(19) United States
(12) Patent Application Publication
(10) Pub. No.: US 2010/0116262 A1
(43) Pub. Date: May 13, 2010

(54) BARBEQUE COOKER

(76) Inventor: Albertus Cornelius Voges, Vereeniging (ZA)

Correspondence Address: BARNES & THORNBURG LLP, 750-17TH STREET NW, SUITE 900, WASHINGTON, DC, 20006-4675, US

(21) Appl. No.: 12/598,167

(22) PCT Filed: Apr. 30, 2008
(86) PCT No.: PCT/IB08/51680

§ 371 Date: Dec. 14, 2009

(30) Foreign Application Priority Data
Apr. 30, 2007 (ZA) 2007/00192

(51) Int. Cl. A47J 37/07; A47J 37/04

(52) U.S. Cl. 126/25 R

(57) ABSTRACT

The invention relates to a barbeque cooker assembly which includes a base, a kettle assembly supported on the base, a fuel receptacle support and associated fuel receptacles, the support including a substantially upright shaft having a lower end which is rotatably supported on the base below the drum or kettle assembly and an upper end which is located in the drum or kettle assembly. The open-topped fuel receptacles are releasably mounted to the fuel receptacle support for receiving fuel for cooking food, and an electric motor supported on the base below the drum or kettle assembly for rotatingly driving the fuel receptacle support and, accordingly, each fuel receptacle mounted thereon. The food to be grilled remains stationary on an elevated grid mounted above the fuel buckets.

THIS INVENTION relates to a barbeque cooker. It more particularly relates to a barbeque cooker assembly, and to a kit for forming such a barbeque cooker assembly.

In accordance with one aspect of the invention there is provided a barbeque cooker assembly which includes:

a base for location on a surface above which the cooker is to be used;

a drum or kettle assembly supported on the base;

a fuel receptacle support comprising an upright shaft having a lower end which is rotatably supported on the base below the drum or kettle assembly and an upper end which is located in the drum or kettle assembly, and at least one fuel receptacle mounting formation fast with the shaft at or adjacent its upper end for releasably mounting a fuel receptacle on the shaft;

at least one generally wedge-shaped open-topped fuel receptacle releasably mounted, via a said fuel receptacle mounting formation, on the fuel receptacle support for receiving fuel for cooking food, each fuel receptacle projecting laterally from and radiating away from the shaft of the fuel receptacle support;

an electric motor supported on the base below the drum or kettle assembly and rotatingly drivingly connected to the shaft of the fuel receptacle support for rotating the fuel receptacle support and, accordingly, each fuel receptacle mounted thereon; and

a grid seat formation provided by the drum or kettle assembly for seating a grid above and over each fuel receptacle.

The cooker assembly may also include a grid seated on the grid seat formation, the grid seat formation being located such that the grid seated thereon is located in the drum or kettle assembly.

Thus, in use, the grid and, accordingly, food received thereon, are stationary, with each fuel receptacle and, accordingly, burning fuel located therein, rotating about an upright axis relative to the food.

The drum or kettle assembly may include a tray located on and resting on the base, a peripheral skirt located on and projecting upwardly from the tray, and an openable and removeable lid located on an upper edge of the skirt. The tray may be shaped for receiving and retaining water, which water in use, on the one hand, serves to shield the electric motor from heat generated by burning fuel in each fuel receptacle and, on the other hand, serves to catch liquids, e.g. fat, dripping from food on the grid past each fuel receptacle. Naturally, the tray is provided with an opening for passing through the shaft of the fuel receptacle support. The tray may further define at least one ventilation opening. The grid seat formation may be fast with the skirt. The grid seat formation may comprise a plurality of spaced grid brackets fast with the skirt and projecting radially inwardly therefrom below its upper edge.
The lid of the drum or kettle assembly may be provided with a handle and with at least one ventilation opening. The lid may also include an adjustment arrangement associated with each ventilation opening for permitting adjustment of the size of each ventilation opening.

The base may include a support portion for more or less horizontally supporting the drum or kettle assembly, i.e. the tray of the assembly, and at least one leg fast with and projecting downwardly from the support portion. Each leg may be releasably secured to the support portion, thereby permitting, on the one hand, collapsing of the cooking assembly to facilitate handling, transport and stowage thereof and, on the other hand, depending on the height of a surface above which the cooking assembly is to be used, securing of legs of different lengths to the support portion. The cooker assembly may include two sets of legs, the legs of one set being relatively short, and the legs of the other set being relatively long.

The base may include at least one electric motor support supporting the electric motor, each electric motor support being moveably mounted on the support portion of the base, for permitting for alignment of the motor relative to the fuel receptacle support. Advantageously, each electric motor support and its moveability relative to the remainder of the base will be such that the electric motor and the fuel receptacle support are self-aligning. The motor may be pendulously suspended from the electric motor support by way of flexible tethers which allow for torsional movement of the electric motor about a vertically extending axis of the cooker when the electric motor is activated.

Each fuel receptacle may include a floor which, by virtue of the shape of the receptacle, is generally wedge shaped when seen face-on, a peripheral side wall fast with and projecting operatively upwardly from edges of the floor, and a mounting formation fast with the side wall and releasably interacting with a said fuel receptacle mounting formation of the fuel receptacle support. Each fuel receptacle may be provided with a grid located above the floor of the receptacle for receiving fuel and for passing ashes as the fuel burns, the grid typically being fast with the side wall of the receptacle. Further, the side wall of each fuel receptacle may be provided with a plurality of ventilation openings spaced below the grid. The ventilation openings may also, if desired, be spaced somewhat above the floor, to permit for receipt of water in the fuel receptacle below its grid. In another embodiment, ventilation may be accomplished by at least one horizontally extending hollow cross-bar extending across the interior of the or each fuel receptacle, the or each said cross-bar having terminal openings serving as air inlets and longitudinally spaced air outlets in the interior of the or each fuel receptable through which air may be ventilated into the or each fuel receptacle. As such, the or each cross-bar may be dimensioned internally to provide a venturi effect to ensure sufficient ventilation of the interior of the or each fuel receptacle.

The cooker assembly may, in some embodiments, also include a worktop releasably connected to the base, the worktop projecting radially outwardly from and surrounding at least part of the support portion of the base of the drum or kettle. The worktop may include at least one worktop connector connected to the base and at least one flat and planar worktop panel connected to a said at least one worktop connector. In addition, the or each leg may also include an attachment formation to which further trays or worktops may be connected.

The cooker assembly may also include a carrier member for connection to the fuel receptacle support, to permit easy handling of the fuel receptacle support and, accordingly, each fuel receptacle mounted thereon, even when fuel in each receptacle is still burning, or when each fuel receptacle is still hot, the carrier member comprising an elongated stem for connection to the fuel receptacle support and a handle fast with the stem.

In a further embodiment the cooker may be provided with a horizontal rotisserie-style rotator, which can be used to cook or grill meat on a rotisserie. The rotator may similarly be electrically driven. In addition, the grid may be provided with additional radially spaced handles, typically four, which may serve to support a second, elevated grid thereupon.

In accordance with another aspect of the invention there is provided a kit for forming a barbeque cooker as hereinbefore described, the kit comprising, in disassembled form, the parts or components of the barbeque cooker assembly as hereinbefore described.

The kit, with all its parts or components assembled together as hereinbefore described with reference to the barbeque cooker assembly, thus forms the barbeque cooker assembly in accordance with the invention.

The invention is now described, by way of non-limiting example, with reference to the accompanying diagrammatic drawings.

In the drawings:

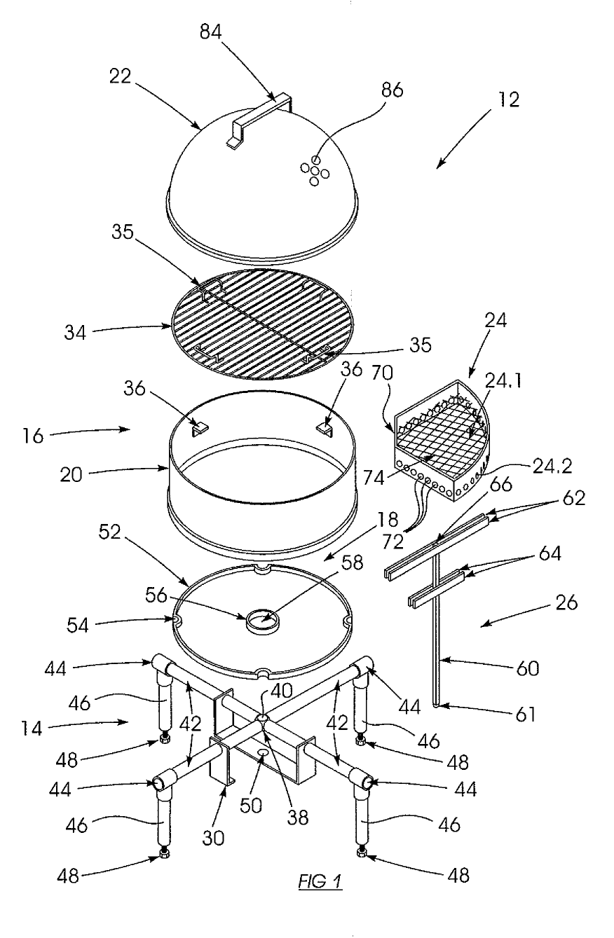

FIG. 1 shows, schematically and in part, an exploded three-dimensional view of a barbeque cooker assembly in accordance with one aspect of the invention;

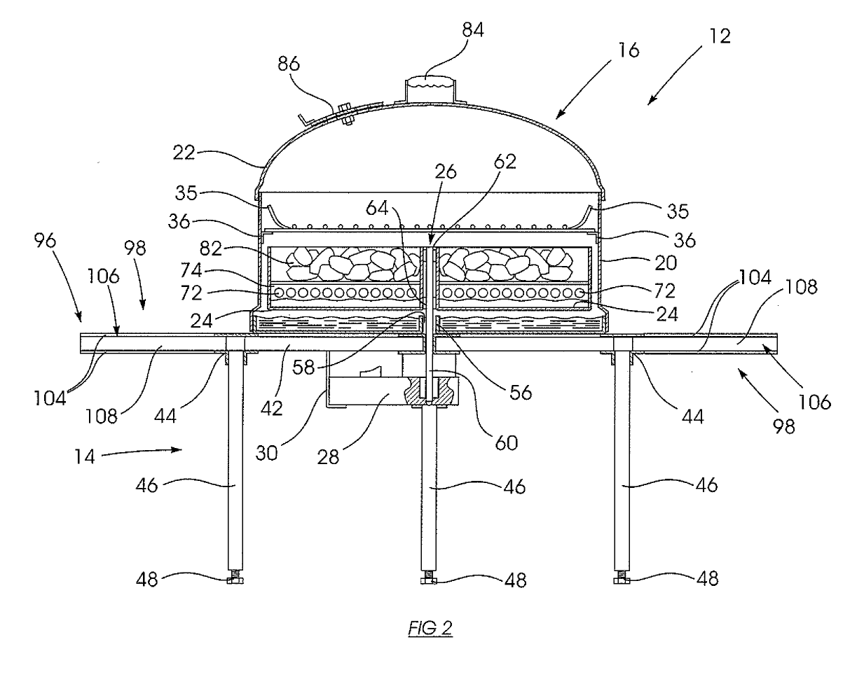

FIG. 2 shows, schematically, a sectional side elevation of the barbeque cooker assembly in accordance with the invention, the cooker being formed from a kit in accordance with the invention;

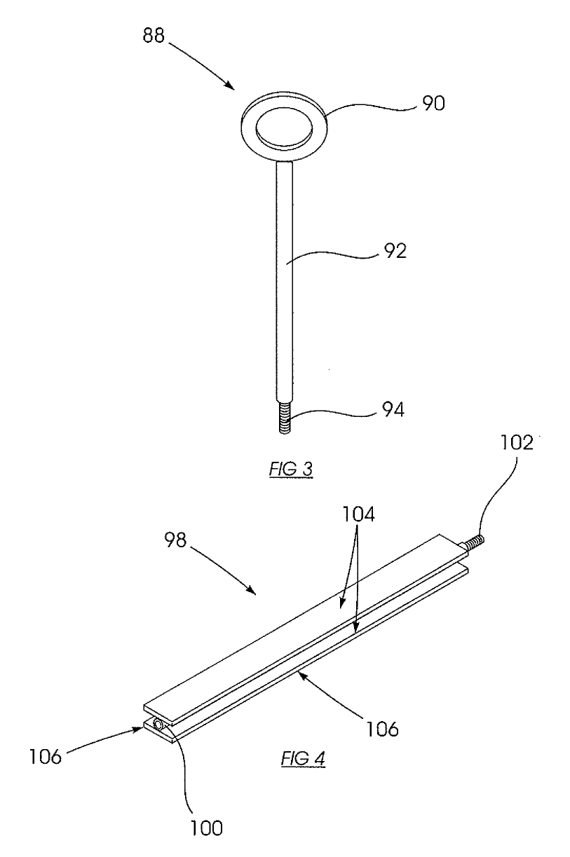

FIG. 3 shows, schematically, a three-dimensional view of a carrier member forming part of the barbeque cooker assembly;

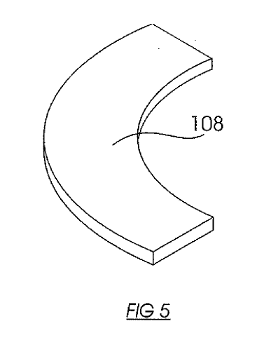

FIG. 4 shows a three-dimensional view of a work top connector;

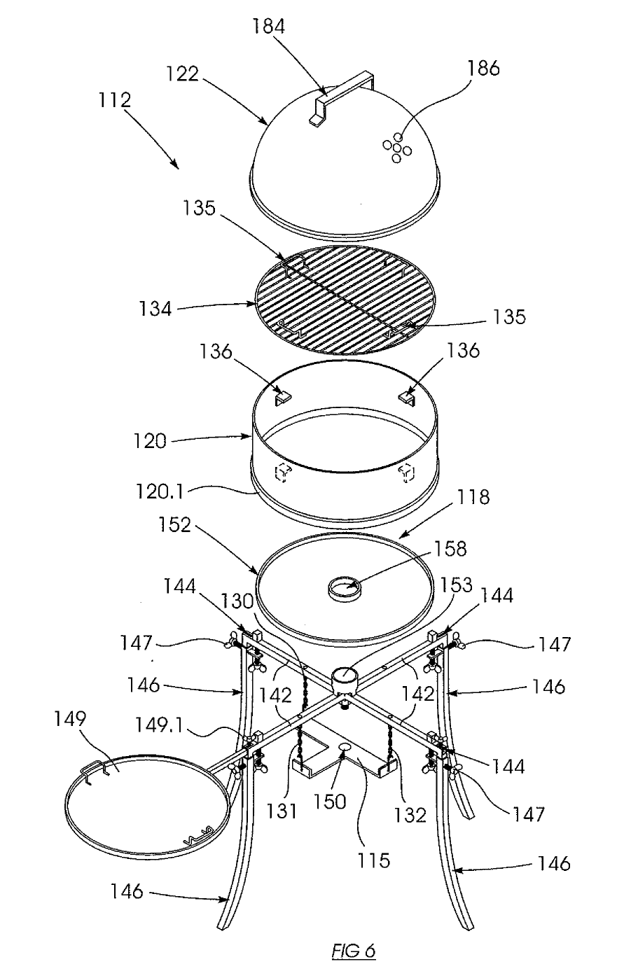

FIG. 5 shows, schematically, a three-dimensional view of a worktop connector forming part of a worktop of the barbeque cooker assembly;

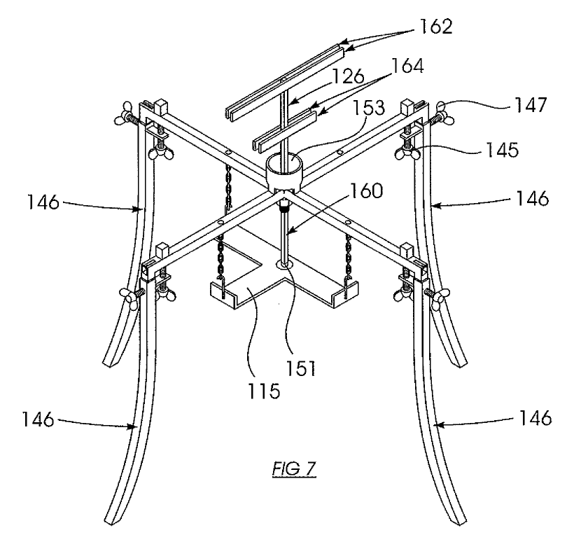

FIG. 6 shows an exploded view of a partially assembled barbeque cooker assembly in accordance with another aspect of the invention;

FIG. 7 shows another exploded view of a partially assembled barbeque cooker assembly in accordance with another aspect of the invention;

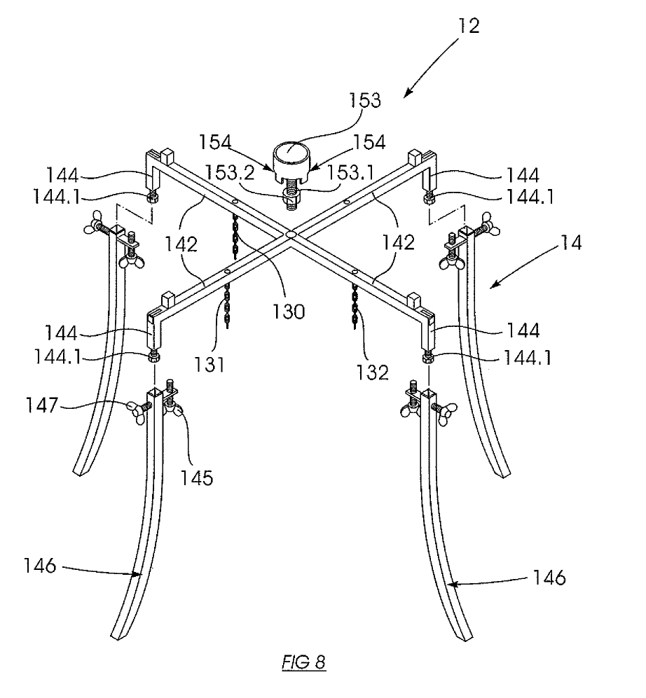

FIG. 8 shows yet another exploded view of a partially assembled barbeque cooker assembly in accordance with another aspect of the invention;

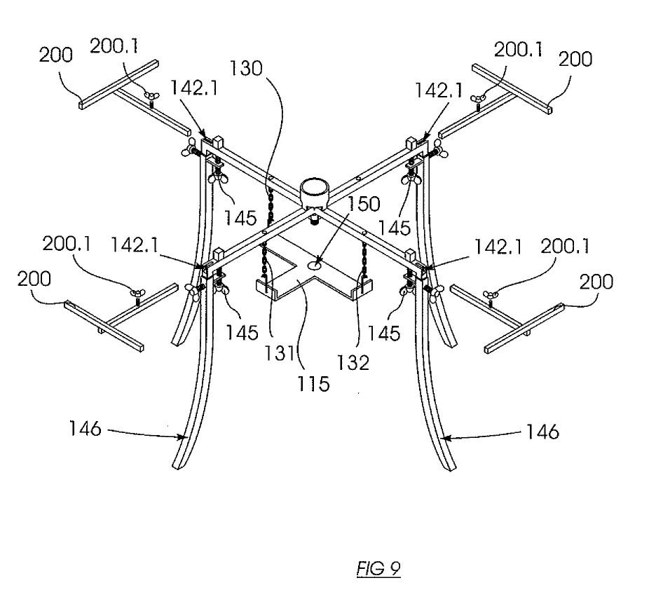

FIG. 9 shows a further exploded view of a partially assembled barbeque cooker assembly in accordance with another aspect of the invention;

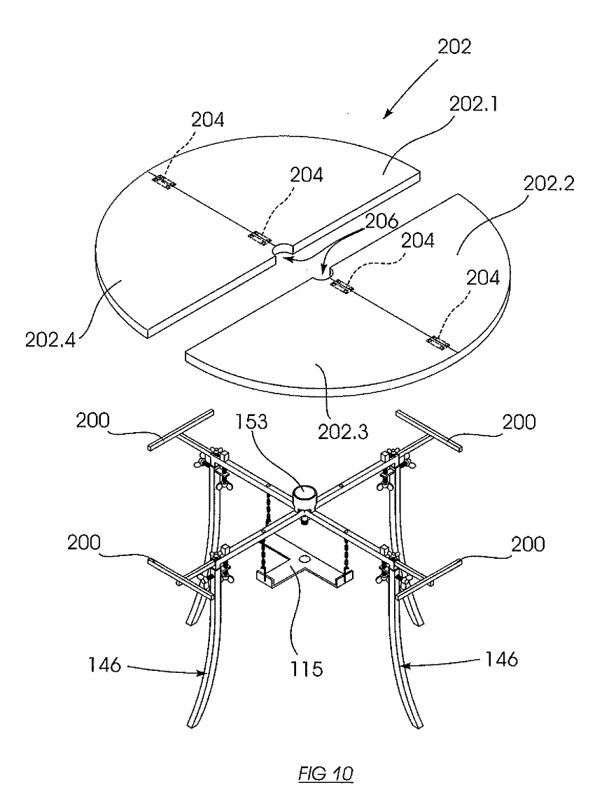

FIG. 10 shows an exploded view of a partially assembled barbeque cooker assembly in accordance with another aspect of the invention, including a tabletop; and

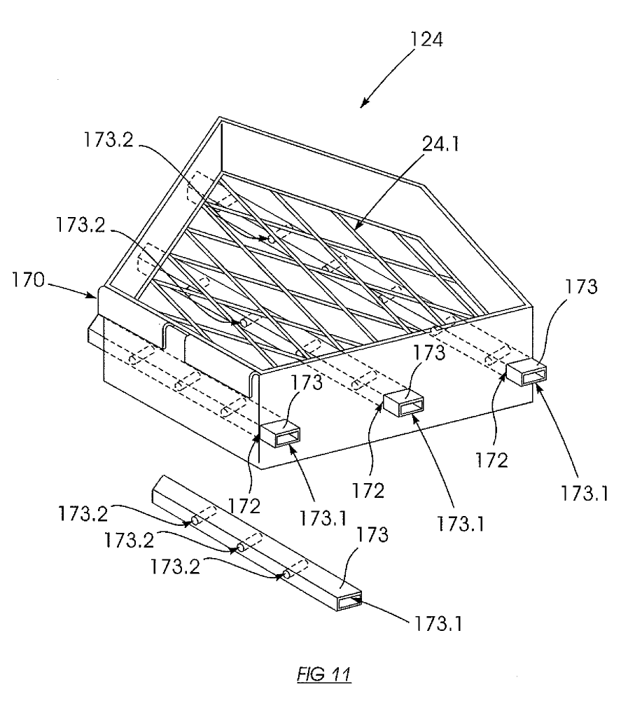

FIG. 11 shows a three-dimensional view of one embodiment of a fuel bucket forming part of a barbeque cooker assembly in accordance with the invention; and

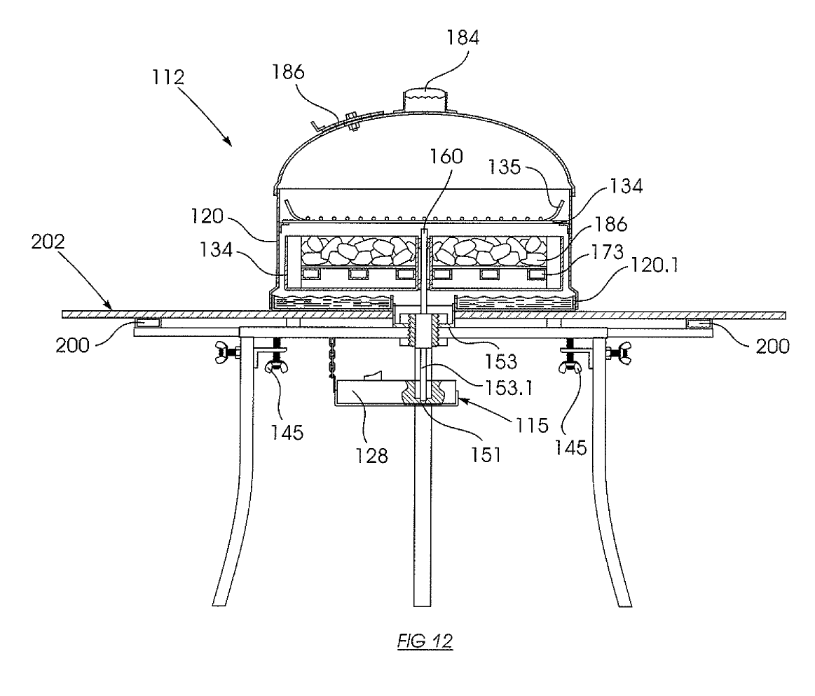

FIG. 12 shows a sectional side view of a barbeque cooker assembly in accordance with another aspect of the invention.

With reference to the drawings in FIGS. 1 to 5, a first embodiment of a barbeque cooker assembly in accordance with the invention is generally designated by reference numeral 12. The cooker 12 is formed from a kit in accordance with the invention and the cooker 12, as will become more apparent hereunder, is collapsible to facilitate handling, transport and stowage thereof.

The cooker 12 includes a framework-like base or stand 14 for location on a surface, e.g. the ground, where the cooker 12 is to be used. A drum or kettle assembly, generally designated by reference numeral 16, is located on top of and supported by the base or stand 14. The drum assembly 16 includes a circular tray 18 that rests on the base 14, a circular cylindrical skirt 20 located on and resting on the tray or base 18, and a dome-shaped lid 22 for location on an upper edge of the skirt 20 to close the drum assembly 16. In this embodiment, the skirt 20 is of one-piece construction. In other embodiments (not shown), the skirt 20 can be diametrically split, to facilitate location thereof. In such a case, the skirt 20 can be provided with a clamp or clamps for retaining the skirt 20, at each split, together.

The cooker 12 further includes two fuel receptacles in the form of truncated wedge-shaped fuel buckets 24 for receiving fuel, and an elongated fuel receptacle support 26 supporting the fuel buckets 24 in the drum assembly 16, as described in more detail hereunder.

The cooker 12 further includes an electric motor 28 (FIG. 2) for rotating the fuel receptacle support 26 and, accordingly, the fuel buckets 24 secured thereto and supported thereby about an upright, typically vertical, axis. The motor 28, as can be seen in FIG. 2, is secured to the base 14 by means of two motor supports 30, 32 fast with the base 14.

The cooker 12 further includes a circular grid 34 provided with two handles 35 for facilitating handling thereof, the grid 34 in use, as can be seen in FIG. 2, being received above the fuel buckets 24, into an upper end of the skirt 20. To provide for location of the grid 34 in the skirt 20, the skirt 20 is provided with four grid brackets 36 projecting radially inwardly from the skirt 20.

Referring now in particular to the base 14, it includes a support portion comprising a central crosspiece 38 provided with a circular central opening 40 for passing, as will be described in more detail hereunder, the fuel receptacle support 26, four elongated arms 42 fast with and radiating outwardly from the central crosspiece 38, and a T-piece connector 44 fast with a free end of each of the arms 42. The base 14 further includes a leg 46 connected to each of the T-piece connectors 44, the legs 46 projecting operatively downwardly from the arms 42. In the embodiment shown in FIG. 1, the legs 46 are relatively short, thereby permitting the cooker 12 to be located in a built-in fireplace or braai. In turn, the legs 46 forming part of the cooker 12 shown in FIG. 2, are relatively long, thereby permitting location of the cooker 12 on the ground. Typically, the cooker 12 will include two sets of legs 46, the legs of one set being relatively short, such as shown in FIG. 1, the legs of the other set being relatively long, such as shown in FIG. 2. To provide for levelling of the tray 18 once the cooker 12 is operatively positioned on a surface, each of the legs 46, at a free end thereof, is provided with an adjustable foot 48.

To assemble the cooker 12 from the kit in accordance with the invention, the stand 14 is operatively located on a surface, for example in the case of FIG. 2 the ground, above which food is to be cooked. The electric motor 28 is now located on the motor supports 30, 32. To provide for self-alignment of the motor 28 and the fuel receptacle support 26, the motor support 30 is pivotally secured to its associated arm 42, and the motor support 32 is also pivotally secured to its associated arms 42. The motor support 32 is generally in the form of a stirrup, with an upwardly facing ball bearing 50 being fast with a base of the stirrup. The tray 18 is now located on top of the stand 14. Drum or kettle assemblies of various sizes can be supported by the base 14. Trays 18 with various diameters can thus be accommodated by the stand 14. Naturally, the skirt 20, the lid 22, the fuel buckets 24 and the grid 34 will be selected in accordance with the size of the tray 18. As can be seen in FIG. 2, the tray is provided with a number of downwardly depending indentations or ridges by means of which it rests on the arms 42 of the base 14.

The tray 18 is provided with an upwardly projecting rim 52 which together with a floor of the tray 18 defines four circumferentially spaced ventilation recesses 54, the purpose of which will become more apparent hereunder. At its centre, the tray 18 is provided with a central rim 56 defining a central opening 58 for passing a stem 60 of the fuel receptacle support 26. As can be seen, the stem 60 has a square cross-sectional profile. Two opposing crossbars 62 are secured to an operatively upper end of the stem 60 and two shorter crossbars 64 are secured, in similar opposing fashion, to the stem 60 below the crossbars 62. In use, as will be described further hereunder, the fuel buckets 24 are releasably secured to the fuel receptacle support 26 by means of the crossbars 62, 64. At its upper end, the stem 60 is provided with an internally screw-threaded passage 66, the purpose of which will be described hereunder.

Referring now to the fuel buckets 24, each of them has a flat fuel bucket floor 24.1, which is generally truncated wedge-shaped, and a fuel bucket side wall 24.2 extending along and projecting operatively upwardly from edges of the floor 24.1. By virtue of its truncation, an operatively inner end of each fuel bucket 24 is flat, and each fuel bucket 24 is provided with a lip 70 projecting away from the flat part of the side wall 24.2 extending along said flat inner end of the fuel bucket 24. Further, each fuel bucket 24 is, in its wall 24.2, provided with a series of ventilation openings 72 spaced upwardly from the floor 24.1 of the bucket 24. As shown in FIG. 2, if desired, each fuel bucket 24, in its side wall 24.2, can be provided with a further series of ventilation openings spaced above the ventilation openings 72. A grid 74 of expanded metal construction is located in each fuel bucket, the grid 74 being spaced above the ventilation openings 72, and if applicable below said further series of ventilation openings, and being secured to the wall 24.2 of the associated fuel bucket 24. In order to secure the fuel buckets 24 to the fuel receptacle support 26, the lip 70, which is longitudinally interrupted, of each fuel bucket 24 is received over one of the crossbars 62 of the support 26. An inner lower edge of each fuel bucket 24, when its lip 70 is received over the crossbar 62, rests on the associated crossbar 64, thereby to ensure that the floor 24.1 of each fuel bucket 24 is more or less perpendicular to an axis of the stem 60 of the support 26.

The stem 60 of the fuel receptacle support 26 is now received through the central opening 58 of the tray 18 and through the central opening 40 of the central crosspiece 38. The electric motor 28 is provided with a through passage having a square cross-sectional profile through which the lower end of the stem 60 is received. Further, at its lower end, the stem 60 is provided with a concave seat (not visible) which engages and rests on the ball bearing 50, thereby facilitating rotation of the fuel receptacle support 26, about the axis of its stem 60, by means of the electric motor 28. As briefly mentioned above, because of the pivotal connection of the motor supports 30, 32 to the stand 14, and by virtue of the ball bearing 50 and the concave seat there is no need for accurate alignment of the through passage of the motor 28 and the stem 60 of the fuel receptacle support 26, in that they are self-aligning.

Once the fuel buckets 24 are in place, the skirt 20 is received on top of the tray 18, i.e. over the fuel buckets 24. As can be seen in FIGS. 1 and 2, the skirt 20, at its operatively lower end, is provided with a shoulder by means of which it is seated on the rim 52 of the tray 18.

Fuel, for example wood, coal, or charcoal in briquette form, is now received, on top of their grids 74, in the fuel buckets 24. The fuel is generally designated by reference numeral 82. The fuel 82 can now be ignited or set alight. Water or wood chips, typically flavoured chips for creating a smoked food flavour in the food on the grid 34, can, if desired, be received in each fuel bucket 24 below its grid 74. Further, in order to provide for easy cleaning of the tray 18, and to provide for easy levelling of the cooker 12, water can be received in the tray 18. The grid 34 is received in the upper end of the skirt 20 and located on the grid brackets 36. Food, for example meat, vegetables, or the like, to be cooked, in particular grilled, can now be received on the grid 34. When food is received on the grid 34, the electric motor 28 is energised such that it rotates the fuel buckets 24 about a central, vertical, axis of the cooker 12. Thus, food located on the grid 34, which is stationary, is not permanently exposed to direct heat from the burning fuel 82 located in the fuel buckets 24. By virtue of the generally wedge-shape of each of the fuel buckets 24, food located at or adjacent a centre of the grid 34 is exposed to more or less the same heat as food located at or adjacent a periphery of the grid 34. In another embodiment (not shown), the fuel bucket is hexagonal or octagonal, and allows a user to place foodstuffs which have been cooked but need to remain warm towards an outer edge of the grill, away from the fuel buckets 24. If required, the lid 22 can be used to close the top of the drum or kettle assembly 16, by location thereof on an upper edge of the skirt 20. To facilitate handling of the lid 22, it is provided with a handle 84. In use, even with the lid 22 closing the drum assembly 16, air can still enter the drum assembly 16 by means of the ventilation recesses 54. To regulate air circulation through the drum assembly 16 when it is closed, the lid 22 is provided with a ventilation arrangement 86, which arrangement 86 is mounted on the lid 22. The ventilation arrangement 86 is of conventional construction and, accordingly, is not described further.

Referring now to FIG. 3 of the drawings, a carrier member forming part of the kit in accordance with the invention and, accordingly of the cooker 12, is generally designated by reference numeral 88. The carrier member 88 includes a handle or handle portion 90 and an elongated stem or stem portion 92 fast with and projecting form the handle 90. A free end of the stem 92 is provided with an external screw-thread 94. In use, especially when the fuel buckets 24 and the fuel receptacle support 26 are still hot, they can be removed from the remainder of the cooker 12 by screwing the lower end of the stem 92 of the carrier member 88 into the screw-threaded passage 66 of the fuel receptacle support 26. The fuel receptacle support 26 and the fuel buckets 24 are then removed by means of the carrier member 88, which permits easy handling thereof.

In certain embodiments, such as the one shown in FIG. 2, the cooker 12 can also include a worktop 96 at least partially surrounding the support portion of the base 14 and, accordingly, the drum assembly 16. The worktop 96 includes four worktop connectors 98 (FIG. 4) which are secured, as described hereunder, to the base 14, and four flat planar worktop panels 108 supported by the connectors 98.

Each worktop connector 98 includes an elongated shaft 100 which, at one end thereof, is provided with a spigot-type connector formation, which in this example is provided with an external screw-thread 102, by means of which the connector 98 is secured to one of the T-piece connectors 44 forming part of the stand 14, and two opposing longitudinally extending flat plates 104 secured to the shaft 100. As can be seen, the plates 104 define between them two sidewardly opening channels 106 within which edges of the worktop panels 108, en example of which is shown in FIG. 5, are received. At operative free ends of the worktop connectors 98, at least one of them, can be provided with a hook or the like for hanging of cooking utensils such as thongs and the like.

With reference to the drawings in FIGS. 6 to 13, a second embodiment of a barbeque cooker assembly in accordance with the invention is generally designated by reference numeral 112. Similarly, this embodiment of a cooker 112 can be formed from a kit in accordance with the invention and the cooker 112 is collapsible to facilitate handling, transport and stowage thereof.

Referring to FIG. 6, the cooker 112 includes a framework-like base or stand 114 for location on a surface, e.g. the ground, where the cooker 112 is to be used. The base 114 and assembly thereof is described hereinafter. A drum or kettle assembly, generally designated by reference numeral 116, is located on top of and supported by the base or stand 114. The drum assembly 116 includes a circular tray 118 that rests on the base 114, a circular cylindrical skirt 120 located on and resting on the tray or base 118, and a dome-shaped lid 122 for location on an upper edge of the skirt 120 to close the drum assembly 116. In this embodiment, the skirt 120 is of unitary construction. In certain embodiments, the skirt is octagonal or hexagonal in shape to allow a user to place food which is cooked, but which needs to be kept warm, in the corners of the skirt.

The cooker 112 further includes two fuel receptacles in the form of truncated wedge-shaped fuel buckets 124 (shown in greater detail in FIG. 11) for receiving fuel, and an elongated fuel receptacle support 126 (best seen in FIG. 7) supporting the fuel buckets 124 in the drum assembly 116, as described in more detail hereunder.

As before, the cooker 112 includes an electric motor 128 (FIG. 12) for rotating the fuel receptacle support 126 and, accordingly, the fuel buckets 124 secured thereto and supported thereby about an upright, typically vertical, axis. The motor 128 is suspended in a motor support cradle 115 from the base 114 by means of three chains 130, 131, 132 tethered to the base 114. Advantageously, the Inventor has found that the chains 130, 131, 132 provide a clutch-like twist effect when the electric motor 128 is activated, which makes rotational operation of the fuel buckets 124 smoother and places less strain on the motor 128.

The cooker 112 further includes a circular grid 134 (which may be hexagonal or octagonal when the skirt 120 is of a corresponding shape) provided with handles 135 for facilitating handling thereof, the grid 134 in use, as can be seen in FIG. 12, being received above the fuel buckets 124, into an upper end of the skirt 120. To provide for location of the grid 134 in the skirt 120, the skirt 120 is provided with four grid brackets 136 projecting radially inwardly from the skirt 120. The provision of four handles on this grid allows a user to place another grid (not shown) on top of the handles of the lower grid, thereby effectively doubling the amount of grid area available for cooking food.

Referring now in particular to the base 114, best seen in FIGS. 8 and 9, it includes a support portion comprising a central crosspiece 138 provided with a circular central opening 140 for passing, as will be described in more detail hereunder, the fuel receptacle support 126, four elongated arms 142 fast with and radiating outwardly from the central crosspiece 138, and a terminal stanchion 144 fast with a free end of each of the arms 142. The crosspiece comprises two elongate sections (not illustrated), which engage each other with a central joint, making the assembly easy to assemble or disassemble and which also results in space-savings when shipped or stored. The base 114 further includes a slightly curved leg 146 connected to each of the terminal stanchions 144, the legs 146 projecting operatively downwardly from the arms 142. As such, the base 114 can be supported on the stanchions 144, thereby permitting the cooker 112 to be located in a built-in fireplace. The stanchions 144 have adjustable turnscrews 144.1 (best seen in FIG. 8) attached thereto which allow the base 144 to be levelled. As before, the turnscrews 144.1 are dimensioned to be receivable inside each of the legs 146. In turn, the legs 146 forming part of the cooker 112 shown in FIGS. 8 and 9 are relatively long, thereby permitting location of the cooker 112 on the ground. Typically, the cooker 112 will include two sets of legs 146, the legs of one set being relatively short and the legs of the other set being relatively long. To provide for levelling of the tray 118 once the cooker 112 is operatively positioned on a surface, each of the legs 146, at an operatively upper end thereof, is provided with an adjustable turnscrew 145 which abuts an underside of each arm 142. Further fasteners 147 are provided transverse to the adjustable turnscrew 145 to secure the legs 146 to the stanchions 144 once the cooker 112 is level. A further tray 149 (best seen in FIG. 6) for holding food to be cooked is securable to an end of each arm 142 by way of a turnscrew 149.1. In addition, as shown in FIGS. 9 and 10, additional T-pieces 200 may similarly be slotted into the ends of the arms 142.1 which, when secured via further fasteners 200.1, provides a stable base on which a collapsible worktop unit 202 is attachable. The worktop is in the form of four sections, 202.1, 202.2, 202.3, 202.4, which are hinged in pairs using piano hinges, shown generally by 204, and, in use, define a central aperture 206 which is snugly receivable about the collar formation 153. This is best seen in the cross-section shown in FIG. 12.

To assemble the cooker 112 from the kit in accordance with the invention, the stand 114 is operatively located on a surface. The electric motor 128 is now located on the motor support cradle 115. The provision of the chains 130, 131, 132 ensures self-alignment of the motor 128 and the fuel receptacle support 126. The motor support cradle 115 is generally in the form of a stirrup, with an upwardly facing ball bearing 151 being fast with a base of the stirrup. The tray 118 is now located on top of the stand 114. Drum or kettle assemblies of various sizes can be supported by the base 114. Trays 118 with various diameters can thus be accommodated by the stand 114. Naturally, the skirt 120, the lid 122, the fuel buckets 124 and the grid 134 will be selected in accordance with the size and shape of the tray 118. This is best seen in FIGS. 6 to 10.

The tray 118 is provided with an upwardly projecting peripheral rim 152. A collar formation 153 with four circumferentially spaced ventilation recesses 154 is used as a central locating formation for ensuring the tray 118 is securely fitted to the base 114. The collar formation 153 has a central, hollow, threaded shaft 153.1 fast therewith, with which the collar formation 153 is secured to the base 114 using a nut 153.2 (shown in FIG. 8). In embodiments where the base 114 is in two sections (as described hereinbefore), the two sections are also secured to one another using the collar formation 153 and nut 153.1. The ventilation recesses 154 and hollow shaft 153.1 ensure that sufficient air is drawn into the cooker 112, towards the grill 134, when cooking food. At its centre, the tray 118 is provided with a central rim 156 defining a central opening 158 which fits snugly over the collar formation 153 and provides an aperture for the stem 160 of the fuel receptacle support 126 to pass through. The provision of a central air intake lessens the chances of children burning themselves on hot coals through peripheral air openings. As can be seen, the stem 160 has a square cross-sectional profile. Two opposing crossbars 162 are secured to an operatively upper end of the stem 160 and two shorter crossbars 164 are secured, in similar opposing fashion, to the stem 160 below the crossbars 162. In use, as will be described further hereunder, the fuel buckets 124 are releasably secured to the fuel receptacle support 126 by suspending them cantilever fashion from the crossbars 162, 164.

Referring now to the fuel buckets 124 shown in FIG. 11, each bucket 124 has a flat fuel bucket floor 124.1, which is generally truncated wedge-shaped, and a fuel bucket side wall 124.2 extending along and projecting operatively upwardly from the edges of the floor 124.1. By virtue of its truncation, an operatively inner end of each fuel bucket 124 is flat, and each fuel bucket 124 is provided with a lip 170 projecting away from the flat part of the side wall 124.2 extending along said flat inner end of the fuel bucket 124. Further, each fuel bucket 124 is, in its wall 124.2, provided with a series of ventilation openings 172 through which rectangular tubing 173 is passed. Each ventilation tube 173 has open termini 173.1 and a plurality of openings or foraminae 173.2 spaced equidistantly along the length of each tube 173. In use, heat given off by the fuel in each fuel bucket 124 heats the air inside and above each tube 173, with air then being drawn in from the open termini 173.1 of the tubes and being channelled under and through the fuel in each bucket 124 via the opening 173.2. The Inventor has found that this is a particularly effective method of ensuring sufficient ventilation within an interior of the cooker 112, due to the accelerative/venturi effect of the air entering the tubes 173 and being fed directly to the fuel in an even, dispersive manner. As before, a grid 174 of expanded metal construction is located in each fuel bucket, with each grid 174 being spaced above the ventilation openings 172, resting on the tubes 173, and furthermore being secured to the wall 124.2 of the associated fuel bucket 124. In order to secure the fuel buckets 124 to the fuel receptacle support 126, the lip 170, which is longitudinally interrupted, of each fuel bucket 124 is received over one of the crossbars 62 of the support 26. An inner lower edge of each fuel bucket 124, when its lip 170 is received over the crossbar 162, rests on the associated crossbar 164, thereby to ensure that the floor 124.1 of each fuel bucket 124 is more or less perpendicular to an axis of the stem 160 of the support 126.

The stem 160 of the fuel receptacle support 126 is now received through the central opening 158 of the tray 118 and through the central opening 40 of the central collar 153. The electric motor 128 is provided with a passage extending therethrough (see FIG. 12), the passage having a square cross-sectional profile through which a lower end of the stem 160 is passed. At said lower end, the stem 160 is provided with a concave seat (not visible) which engages and rests on the ball bearing 151, thereby facilitating rotation of the fuel receptacle support 126, about the axis of its stem 160, by means of the electric motor 128. As discussed hereinbefore, because of the suspensive connection of the motor support chains 130, 131, 132 to the stand 114, and by virtue of the ball bearing 151 and the concave seat there is no need for accurate alignment of the through passage of the motor 128 and the stem 160 of the fuel receptacle support 126, in that they are self-aligning.

Once the fuel buckets 124 are in place, the skirt 120 is received on top of the tray 118, i.e. over the fuel buckets 124. As can be seen in FIGS. 6 and 12, the skirt 120, at its operatively lower end, is provided with a shoulder 120.1 by means of which it is seated on the rim 152 of the tray 118.

Turning to FIG. 12, fuel, for example wood, coal, or charcoal in briquette form, is now placed on top of the grids 174 inside the fuel buckets 124. The fuel is generally designated by reference numeral 182. The fuel 182 can now be ignited or set alight as before. Food to be cooked or grilled, is then placed on the grid 134. When food is received on the grid 134, the electric motor 128 is activated such that it rotates the fuel buckets 124 about a central, vertical, axis of the cooker 112. Thus, food located on the grid 134, which is stationary, is not permanently exposed to direct heat from the burning fuel 182 located in the fuel buckets 124. By virtue of the generally wedge-shape of each of the fuel buckets 124, food located at or adjacent a centre of the grid 134 is exposed to more or less the same heat as food located at or adjacent a periphery of the grid 134. In another embodiment (not shown), the fuel bucket 124 is hexagonal or octagonal. If required, the lid 122 can be used to close the top of the drum or kettle assembly 116. To facilitate handling of the lid 122, it is provided with a handle 184. In use, even with the lid 122 closing the drum assembly 116, air can still enter the drum assembly 116 by means of the ventilation recesses 154. To regulate air circulation through the drum assembly 116 when it is closed, the lid 122 is provided with a ventilation arrangement 186, which arrangement 186 is mounted on the lid 122. The ventilation arrangement 186 is of conventional construction and, accordingly, is not described further.

In a further embodiment, not shown herein, the cooker 12, 112 is provided with a horizontal rotisserie-style rotator, which can be used to cook or grill meat on a rotisserie. The rotator is also electrically driven in similar fashion to the fuel receptacle support 26, 126.

The invention as described and illustrated thus provides a cooker which can easily be disassembled, and by virtue of legs of various lengths can either be used on the ground or can be located in a built-in barbeque or fireplace. Further, by virtue of the tray 18, 118 of the cooker 12, 118 being fillable with water, the electrical motor 28, 128 is shielded from heat generated by burning fuel used to cook food and fat which has dripped into the water can easily be thrown out with the water, making the installation easy to clean A further advantage of the invention is that, because of the good ventilation provided, less coals are required, resulting in less fossil fuels being used to cook food. Furthermore, spent coals cannot fall out of the cooker and remain enclosed within the cooker until such time as the cooker is cleaned.

1. A barbeque cooker assembly including:
a base for location on a surface above which the cooker is to be used;
a drum or kettle assembly supported on the base;
a fuel receptacle support comprising an upright shaft having a lower end, which is rotatably supported on the base below the drum or kettle assembly, and an upper end, which is located in the drum or kettle assembly, and at least one fuel receptacle mounting formation fast with the shaft at or adjacent its upper end for releasably mounting a fuel receptacle on the shaft;
at least one generally wedge-shaped open-topped fuel receptacle releasably mounted, via the fuel receptacle mounting formation, on the fuel receptacle support for receiving fuel for cooking food, each fuel receptacle projecting laterally from and radiating away from the shaft of the fuel receptacle support;
an electric motor supported on the base below the drum or kettle assembly and rotatingly drivingly connected to the shaft of the fuel receptacle support for rotating the fuel receptacle support and, accordingly, each fuel receptacle mounted thereon; and
a grid seat formation provided by the drum or kettle assembly for seating a grid above and over each fuel receptacle.

2. The assembly of claim 1, having included therein a grid seated on the grid seat formation, the grid seat formation being located such that the grid seated thereon is located within the drum or kettle assembly.

3. The assembly of claim 1, wherein, in use, the grid and, accordingly, food received thereon, are stationary, with each fuel receptacle and, accordingly, burning fuel located therein, rotating about an upright axis relative to the food.

4. The assembly of claim 1, wherein the drum or kettle assembly includes a tray located on and resting on the base, a peripheral skirt located on and projecting upwardly from the tray, and an openable and removable lid located on an upper edge of the skirt.

5. The assembly of claim 1, wherein the tray is shaped for receiving and retaining water.

6. The assembly of claim 5, wherein the tray is provided with an opening through which a shaft of the fuel receptacle support is passed.

7. The assembly of claim 5, wherein the tray further defines at least one ventilation opening.

8. The assembly of claim 1, wherein the grid seat formation comprises a plurality of spaced grid brackets fast with the skirt and projecting radially inwardly therefrom below its upper edge.

9. The assembly of claim 1, wherein the base includes a support portion for more or less horizontally supporting the drum or kettle assembly.

10. The assembly of claim 9, wherein the support portion includes the tray of the assembly, and at least one leg fast with and projecting downwardly from the support portion.

11. The assembly of claim 10, wherein each leg is releasably secured to the support portion.

12. The assembly of claim 10, wherein the cooker assembly includes two sets of legs, the legs of one set being shorter then the legs of the other set.

13. The assembly of claim 1, wherein the base includes at least one electric motor support supporting the electric motor, the electric motor support being moveably mounted to the support portion of the base such that the electric motor support and its moveability relative to the remainder of the base is such that the electric motor and the fuel receptacle support are self-aligning.

14. The assembly of claim 13, wherein the motor support is pendulously suspended from the base by way of flexible tethers which allow for torsional movement of the electric motor about a substantially vertically extending axis of the cooker, upon activation of the electric motor.

15. The assembly of claim 1, wherein each fuel receptacle includes a floor which, by virtue of the shape of the receptacle, is generally wedge shaped when seen face-on, a peripheral side wall being fast with and projecting operatively upwardly from edges of the floor.

16. The assembly of claim 15, wherein each fuel receptacle includes a mounting formation fast with the side wall and releasably interacting with the fuel receptacle mounting formation of the fuel receptacle support.

17. The assembly of claim 15, wherein each fuel receptacle is provided with a grid located above the floor of the receptacle for receiving fuel and for passing ashes as the fuel burns, the grid being fast with the side wall of the receptacle.

18. The assembly as claimed in of claim 15, wherein the side wall of each fuel receptacle is provided with a plurality of ventilation openings spaced below the grid.

19. The assembly of claim 15, wherein the ventilation openings are spaced somewhat above the floor, to permit for receipt of water in the fuel receptacle below its grid.

20. The assembly of claim 15, wherein ventilation is accomplished by at least one horizontally extending hollow cross-bar extending across the interior of each fuel receptacle, each said cross-bar having terminal openings serving as air inlets and longitudinally spaced air outlets in the interior of the or each fuel receptable through which air is ventilated into each fuel receptacle.

21. The assembly of claim 20, wherein each cross-bar is profiled internally to provide a venturi effect of incoming air, to ensure sufficient ventilation of the interior of the or each fuel receptacle.

22. The assembly of claim 1, wherein the cooker assembly includes a worktop releasably connected to the base, the worktop projecting radially outwardly from and surrounding at least part of the support portion of the base of the drum or kettle.

23. The assembly of claim 22, wherein the worktop includes at least one worktop connector connected to the base and at least one flat and planar worktop panel connected to the at least one worktop connector.

24. The assembly of claim 22, wherein each leg includes an attachment formation to which further trays, worktop support, or worktops are connectable.

25. The assembly of claim 1, wherein the cooker assembly also includes a carrier member for connection to the fuel receptacle support, the carrier member comprising an elongated stem for connection to the fuel receptacle support and a handle fast with the stem.

26. The assembly of claim 4, wherein the lid of the assembly is provided with a handle and with at least one ventilation opening.

27. The assembly of claim 26, wherein the lid also includes an adjustment arrangement associated with each ventilation opening for permitting adjustment of the size of each ventilation opening.

28. The assembly of claim 1, including a horizontal rotisserie-style rotator mountable internal to the skirt.

29. The assembly of claim 28, wherein the rotator is electrically driven.

30. The assembly of claim 1, wherein the grid is provided with additional radially spaced handles, which serve to support a second, elevated grid thereupon.

31. A kit for forming a barbeque cooker, the kit comprising, in disassembled form, the parts or components of the barbeque cooker assembly of claim 1.

32. The assembly of claim 1, substantially as herein described and illustrated.

33. The kit of claim 31, substantially as herein described and illustrated.
